(19) United States
(12) Patent Application Publication
(10) Pub. No.: US 2009/0102440 A1
(43) Pub. Date: Apr. 23, 2009

(54) Buck-Boost Switching Voltage Regulator

(75) Inventor: Charles Coles, Milpitas, CA (US)

Correspondence Address: ADVANCED ANALOGIC TECHNOLOGIES, 3230 Scott Blvd, Santa Clara, CA, 95054, US

(73) Assignee: Advanced Analogic Technologies, Inc., Sunnyvale, CA (US)

(21) Appl. No.: 11/877,363

(22) Filed: Oct. 23, 2007

(51) Int. Cl. G05F 1/10

(52) U.S. Cl. 323/271

(57) ABSTRACT

A buck-boost switching regulator includes two buck switches and two boost switches. Two ramp voltages VY and VY are generated. The voltage VY is compared to a voltage VEA1 that is proportional to the output of the switching regulator. This defines the duty cycle of the two buck switches. The voltage VX is compared to a voltage VEA2 that is inversely proportional to the output of the switching regulator. This defines the duty cycle of the two boost switches. The regulator seamlessly transitions between Buck, Boost and Buck-Boost modes depending on input and output conditions.

### BACKGROUND OF THE INVENTION

Switching regulators are intended to be efficient machines for converting a power source from one form to another. The two most common types of switching regulators are Boost (output voltage greater than input voltage) and Buck (output voltage less than input voltage) regulators. Both Boost and Buck regulators are very important for battery powered applications such as cellphones. This particular application relates to a third type of switching regulator where the output voltage can be greater or less than the input voltage. This third type of regulator is known as a Buck-Boost regulator.

As shown in FIG. 1A, a traditional implementation for a Buck regulator includes a switch M1 connected between an input voltage (V_{BATT} in this case) and a node V_{X}. A switch M2 is connected between the node V_{X} and ground. An inductor L is connected between V_{X} and the output node (V_{OUT}) of the regulator. A filtering capacitor connects V_{OUT} to ground. The node V_{OUT} is also connected to a load (not shown).

A control circuit turns switches M1 and M2 ON and OFF in a repeating pattern. M1 is driven out of phase with M2. Thus, when M1 is ON M2 is OFF. This causes the Buck regulator to have two distinct operational phases. In the first phase, shown in FIG. 1B, the switch M1 is ON. During this phase, called the charging phase, the inductor is connected between the battery and the output node V_{OUT}. This causes current to flow from the battery to the load. In the process energy is stored in the inductor L in the form of a magnetic field.

In the second, or discharge phase the switch M1 is opened (see FIG. 1C). In this phase, the inductor is connected in series between ground and the load. Current supplied by the inductor's collapsing magnetic field flows to the output node V_{OUT} and the load.

As shown in FIG. 1D, a typical Boost converter includes all of the components just described. A slightly different topology is used in which the switch M2 is placed between the inductor and the output node. The Boost converter uses the same two phase pattern of switching for its two switches.

In both Buck and Boost regulators, the switch M1 is often referred to as the control switch and the switch M2 is referred to as the free-wheeling switch. The switch M2 is also referred to as a “synchronous rectifier” because the two switches are driven synchronously-when one is ON, the other is OFF. In the real world, this is never quite the case. It takes time to turn the switches ON and OFF and control cannot be done with absolute precision. For this reason, the act of turning a switch OFF is always done slightly in advance of the act of turning the other switch ON. This technique, known as break-before-make or BBM avoids the situation where both switches are ON at the same time and power is connected to ground (a condition known as shoot through). Where efficiency is not as important, the switch M2 may be replaced with a diode, eliminating the need for BBM circuitry.

Switching regulators generally include some form of control circuit to modulate the duty cycle of their switches. These control circuits typically include circuitry that generates a periodic ramp voltage. An example of this is the ramp voltage VX in FIG. 1E. The ramp voltage is one of the inputs to a comparator. The second comparator input is the output of an error amplifier that compares the output voltage to a reference voltage. The output of the comparator (i.e., the comparison between the ramp voltage and the output of the error amplifier) is a periodic square wave signal. In FIG. 1E, this square wave signal is labeled VA. That signal is used to drive one of the switches in the regulator. Its complement is used to drive the second switch. Typically, there is some additional circuitry that ensures that both switches are not simultaneously ON during transitions of the square wave signal and its complement (i.e., BBM circuitry). FIG. 1E also shows a higher feedback voltage (labeled VFB′) and the effect that it has on the duty cycle of the periodic square wave signal. Thus, it can be seen that increasing the feedback voltage results in a increased duty cycle for the regulator.

At their limits, both Buck and Boost regulators approach or equal unity gain (i.e., where output voltage equals input voltage). But neither type of regulator operates beyond this limit. This means that Buck regulators and Boost regulators are capable of only regulating a voltage above or below a given input but are not capable of both step up and step down regulation. This can be a significant disadvantage in applications where the battery voltage can be above and below the regulator output voltage. For example, a single Lithium ion battery typically has a source voltage ranging from 4.2 Volts to 2.7 Volts. If the accompanying device requires 3.3 Volts, then neither Buck nor Boost regulators would be effective since the input voltage can be both above and below the regulator output voltage.

For this reason, several regulator topologies have been developed to provide regulation both above and below the regulator input voltage. The Buck-Boost regulator shown in FIG. 1G is one such topology. This Buck-Boost regulator uses four switches (labeled A, B, C and D) to provide an output at a higher or lower voltage than its input. During operation, switches A and C are switched ON and OFF in tandem. Switches B and D are similarly switched ON and OFF in tandem. The following repeating pattern is typically used: Switches A and C ON, B and D ON, A and C ON, B and D ON and so on.

Unlike the Buck and Boost regulators described above, the Buck-Boost of FIG. 1G operates to provide regulation both above and below the regulator input voltage. Unfortunately, efficiency of this architecture suffers because of the continual switching of four separate switches and a relatively high power loss in the four switches and inductor for a given load. To ameliorate this disadvantage, U.S. Pat. No. 6,166,527 discloses a modified Buck-Boost regulator that operates as a Buck regulator, a Boost regulator and a Buck-Boost regulator depending on input and output conditions. To operate as a Boost regulator, switch A is maintained ON and switch B is maintained OFF. Switches C and D are switched synchronously out of phase with each other. The overall result is a topology that matches the Boost regulator of FIG. 1D and provides step-up regulation. For Buck operation, switch C is maintained OFF and switch D is maintained ON while switches A and B are switched synchronously out of phase with each other. This replicates the function of Buck regulator of FIG. 1A and provides step-down regulation. To operate as a Buck-Boost regulator, all four switches are active. The following repeating pattern is typically used: A and C ON, A and D ON and B and D ON. This causes the regulator to function as interleaved combination of a Boost regulator and a Buck regulator.

A control circuit is used to select between Buck, Boost and Buck-Boost operation. The control circuit generates two ramp voltages (shown as VX and VY in FIG. 1G) and uses two comparators. Each comparator compares one of the ramp voltages to an error amplifier output voltage (VX and VY in FIG. 1G) that is proportional to the output voltage of the regulator. One comparator output turns switch A and switch B ON and OFF out of phase with each other. The second comparator output turns switch C and switch D ON and OFF out of phase with each other. FIG. 1G shows that when the feedback voltage increases to VFB′, the duty cycle of the two switch pairs (A/B and C/D) is changed in response.

In general, this type of Buck-Boost regulator offers increased efficiency when compared to Buck-Boost regulators that require four-switch operation under all input and output conditions. A similar regulator is disclosed in U.S. Pat. No. 5,734,258.

### SUMMARY OF THE INVENTION

An embodiment of the present invention includes a Buck-Boost voltage regulator. The Buck-Boost regulator includes four switches connected in the topology of FIG. 1F. Three operating modes are supported: 1) Boost, Buck and Buck-Boost. For Boost mode operation, switch A is maintained ON, switch B is maintained OFF and switches C and D are switched synchronously out of phase with each other. For Buck operation, switch C is maintained OFF, switch D is maintained ON and switches A and B are switched synchronously out of phase with each other. For Buck-Boost mode, all four switches are active.

A control circuit is used to select between Buck, Boost and Buck-Boost operation. The control circuit includes an error amplifier that outputs a voltage that is proportional to the output of the regulator.

The control circuit generates two sawtooth ramp voltages with a 180 degree phase inversion. Two comparators are used, one for each ramp. Each comparator has a different voltage for comparison to its ramp.

The first comparator compares its ramp voltage to the output of the error amplifier. The second comparator compares its ramp voltage to a voltage that is inverted and offset from the output of the error amplifier.

One comparator output turns switch A and switch B ON and OFF out of phase with each other. The second comparator output turns switch C and switch D ON and OFF out of phase with each other. The result is a Buck-Boost regulator that seamlessly transitions between Boost, Buck and Buck-Boost modes and minimizes the range of input and output voltages that require Buck-Boost mode.

### BRIEF DESCRIPTION OF THE DRAWINGS

FIG. 1A is a block diagram of a prior art Buck switching regulator.

FIG. 1B is a block diagram showing the prior art Buck switching regulator of FIG. 1 during the charge phase of operation.

FIG. 1C is a block diagram showing the prior art Buck switching regulator of FIG. 1 during the discharge phase of operation.

FIG. 1D is a block diagram of a prior art Boost switching regulator.

FIG. 1E is graph showing the feedback and ramp voltages used to control typical prior art switching regulators.

FIG. 1F is a block diagram of a prior art Buck-Boost switching regulator.

FIG. 1G is graph showing the feedback and ramp voltages used to control the Buck-Boost switching regulator of FIG. 1F.

FIG. 2 is a block diagram of a Buck-Boost switching regulator as provided by an embodiment of the present invention.

FIG. 3 is graph showing the relationship between the two ramp voltages used to control the Buck-Boost switching regulator of FIG. 2.

FIG. 4A through 4C are graphs showing the feedback, ramp and switching voltages of the Buck-Boost switching regulator of FIG. 2 under various combinations of input and output conditions.

FIG. 5A through 5D are graphs showing the Buck, Boost and Buck-Boost regions of operations for different configurations of the Buck-Boost switching regulator of FIG. 2.

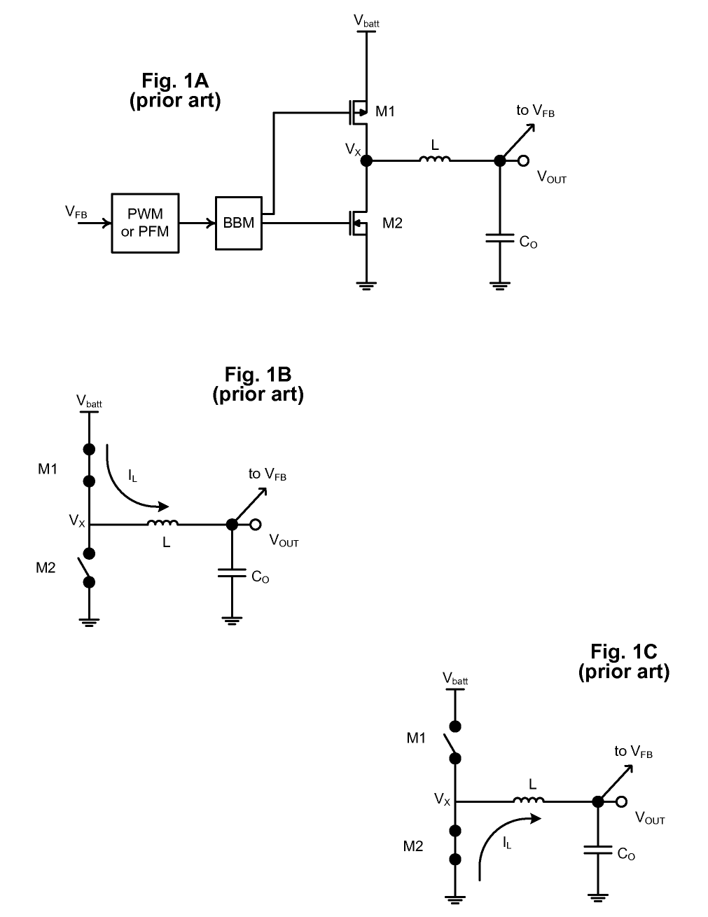

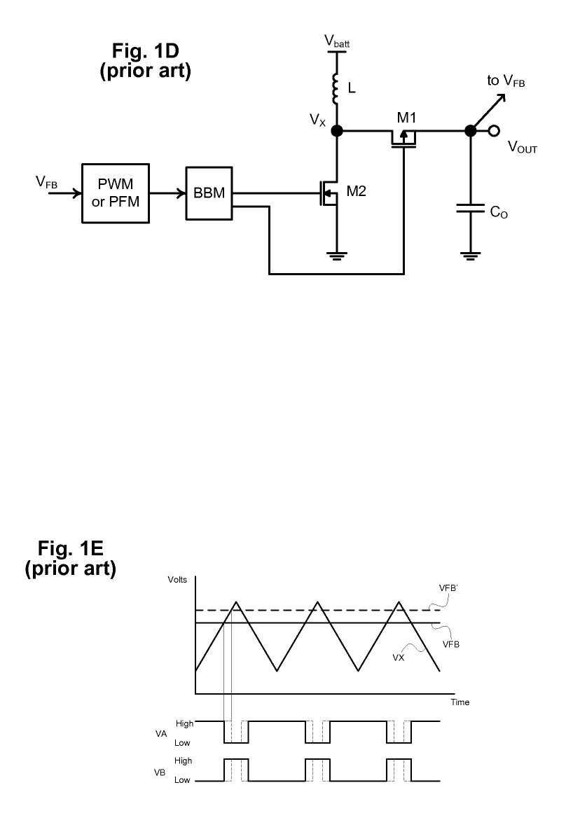

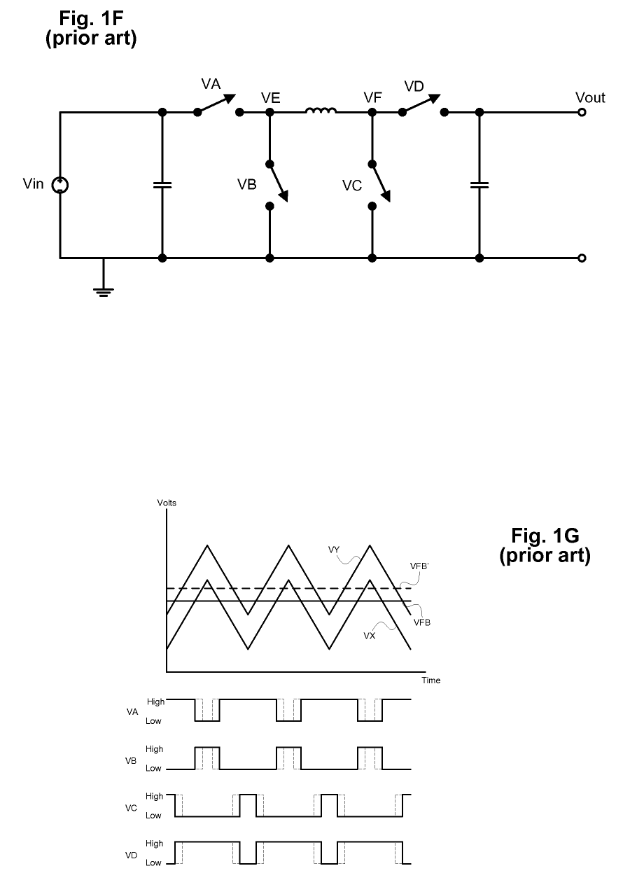

### DETAILED DESCRIPTION OF THE PREFERRED EMBODIMENTS

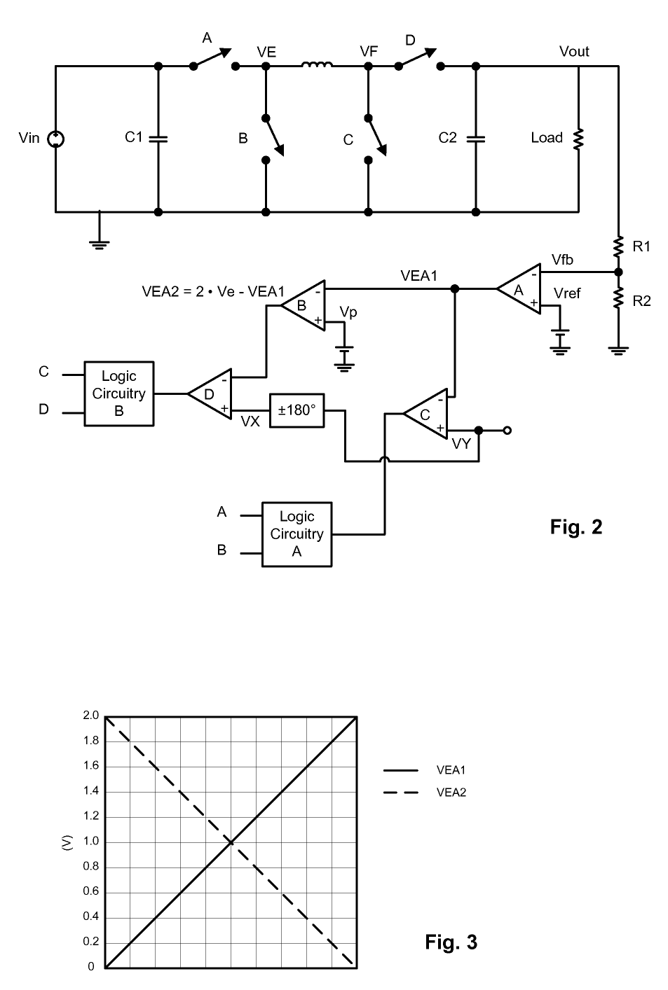

An embodiment of the present invention includes a Buck-Boost voltage regulator. As shown in FIG. 2, a representative implementation of this regulator includes four switches labeled A, B, C and D. Typically, these switches are MOSFET devices with A and D being PMOS devices and B and C being NMOS devices. It should be appreciated however, that other technologies and device types may be used. Switch A is connected between an input supply (labeled Vin) and a node VE. Switch B is connected between the node VE and ground. An inductor (labeled L) connects the node VE to a node VF. Switch C is connected between the node VF and ground. Switch D connects the node VF to an output node Vout. A load (represented by a resistor) connects the output node to ground. Two capacitors are included. The first or input capacitor is connected between the input voltage and ground. The second or output capacitor is connected between the output node (Vout) and ground. The two capacitors are labeled C1 and C2 respectively.

A control circuit is included to control the four switches. The control circuit derives a feedback voltage (Vfb) from the output node Vout using a resistive divider composed of resistors R1 and R2. Vfb is compared to a reference voltage Vref in an error amplifier labeled A. The reference voltage is a preset voltage that may be generated using any convenient method as is well known in the prior art. The output of the error amplifier A is a voltage VEA1. VEA1 is passed to a comparator C where it is compared to a ramp voltage VY. The ramp voltage VY is periodic signal that is typically, but not necessarily a sawtooth wave. This signal may be generated using any convenient method as is well known in the prior art. The ramp voltage VY varies between a minimum of Vv and a maximum of Vp.

As will be shown in more detail, the result of the comparison between the voltage VEA1 and the ramp voltage VY is a square wave signal. This square wave signal is passed to logic circuitry A where it is used to derive complimentary signals for driving switch A and switch B out of phase. Logic circuitry A performs two basic functions: 1) it generates signals of the appropriate voltage to drive switches A and B, and 2) it ensures that there is an appropriate BBM period between deactivation of these switches and the activation of the complementary switch.

For purposes of this description, the switches A and B are referred to as the Buck switches. Logic circuitry A ensures that these two switches are driven out of phase with each other. The amount of time that switch A is ON relative to the amount of time that it is OFF is referred to as the duty cycle of the Buck switches. The duty cycle can vary between zero (0) where switch A is constantly OFF to one-hundred percent (100%) where the switch A is constantly ON. Duty cycle is measured against the period of the ramp voltage VY. So a 50% duty cycle implies that switch A is ON for half of the period of the ramp voltage VY. It should be appreciated that it is possible to replace switch B with a diode. This decreases the overall efficiency of the switching regulator (since there is a voltage drop over the diode) but simplifies the control scheme somewhat.

The VEA1 signal is also passed to an amplifier B where it inverted and offset. The output of error amplifier B is a voltage VEA2 where VEA2=2·Ve−VEA1 and where Ve is typically (but not necessarily) in the range of 0.9 Vp to 1.1 Vp. As shown in FIG. 3, the overall result is that the voltage VEA2 has a slope that is opposite to the slope of VEA1. So, as VEA1 increases VEA2 decreases. VEA2 also has a DC offset relative to VEA1. So, in this particular example, VEA2 is two volts when VEA1 is at zero volts.

VEA2 is passed to a comparator D. The second input to the comparator D is a ramp voltage VX. As shown in FIG. 2, the ramp voltage VY is the ramp voltage VX after a phase shift of 180 degrees (180°) has been applied. The result of the comparison between the voltage VEA2 and the ramp voltage VX is a square wave signal. This square wave signal is passed to logic circuitry B where it is used to derive complimentary signals for driving switch C and switch D out of phase. Logic circuitry B performs two basic functions: 1) it generates signals of the appropriate voltage to drive switches C and D, and 2) it ensures that there is an appropriate BBM period between deactivation of these switches and the activation of the complementary switch.

For purposes of this description, the switches C and D are referred to as the Boost switches. Logic circuitry B ensures that these two switches are driven out of phase with each other. The amount of time that switch C is ON relative to the amount of time that it is OFF is referred to as the duty cycle of the Boost switches. The duty cycle can vary between zero (0) where switch C is constantly OFF to one-hundred percent (100%) where the switch C is constantly ON. Duty cycle is measured against the period of the ramp voltage VX. So a 50% duty cycle implies that switch C is ON for half of the period of the ramp voltage VX. It should be appreciated that it is possible to replace switch D with a diode. This decreases the overall efficiency of the switching regulator (since there is a voltage drop over the diode) but simplifies the control scheme somewhat.

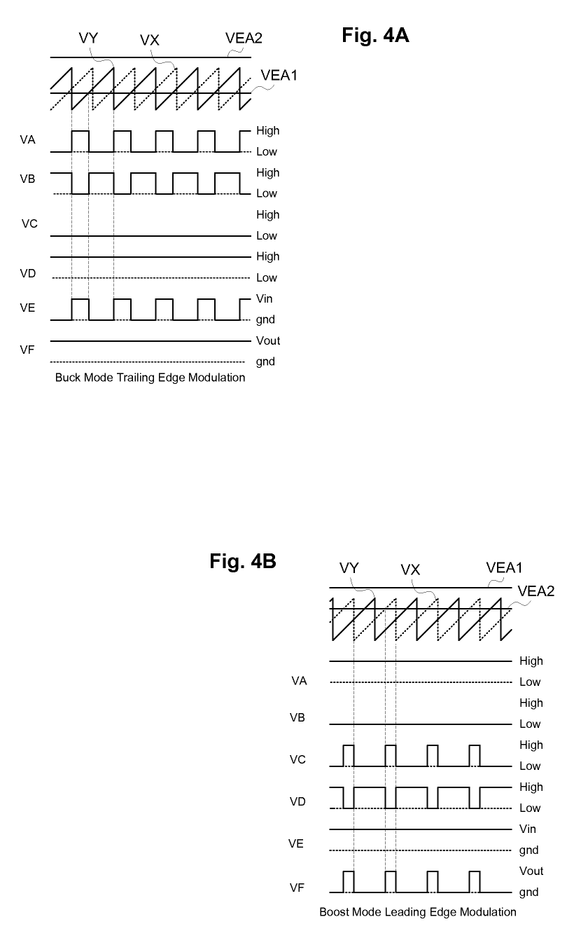

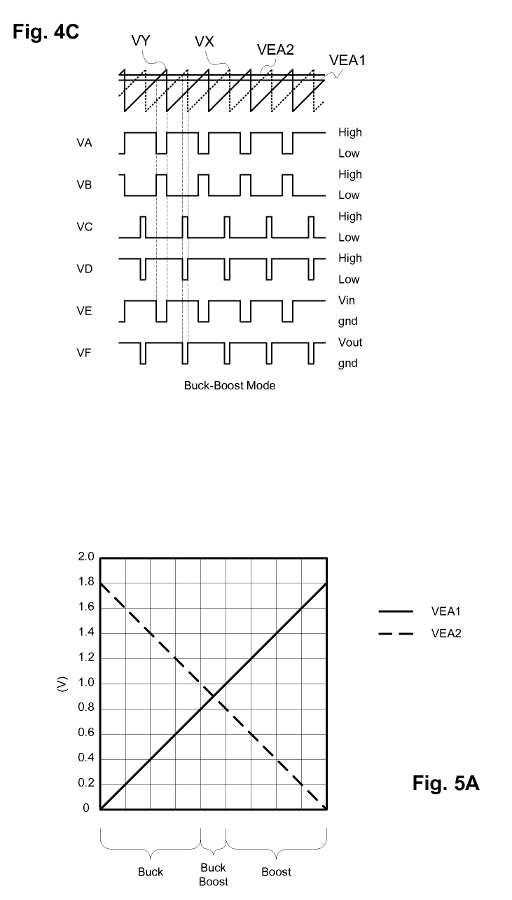

The magnitude of VEA1 and VEA2 determine whether the regulator operates in Buck, Boost or Buck-Boost mode. For example, FIG. 4A shows the case where VEA2 is relatively high and VEA1 is somewhat lower. This means that the ramp voltage VX is not intersected by VEA2. As a result, the output of comparator D does not change and this prevents switches C and D from actively switching with switch D continuously ON and switch C continuously OFF. VEA1, on the other hand does intersect ramp voltage VY. Switch A turns ON with each leading edge of the ramp voltage VY. Switch A turns OFF and switch B turns ON at the intersection of the signal VEA1 and the ramp voltage VY. As is easily appreciated, increasing or decreasing the signal VEA1 changes this point of intersection. This is described as trailing edge modulation. Switch B has a complementary switching pattern. For purposes of this description, FIG. 4A does not show a break-before-make period between switches A and B, but it is understood that such a period would exist in actual implementations. Complementary switching of A and B while D is continuously ON and C is continuously OFF means that the regulator is acting as a Buck regulator. In this case, a Buck regulator with trailing edge modulation.

FIG. 4B shows the case where VEA1 is relatively high and VEA2 is somewhat lower. This means that the ramp voltage VY is not intersected by VEA1. As a result, the output of comparator C does not change and this prevents switches A and B from actively switching with switch A continuously ON and switch B continuously OFF. VEA2, on the other hand does intersect ramp voltage VX. Switch C turns OFF with each trailing edge of the ramp voltage VX. Switch C turns ON at the intersection of the signal VEA2 and the ramp voltage VX. As is easily appreciated, increasing or decreasing the signal VEA2 changes this point of intersection. This is described as leading edge modulation. Switch D has a complementary switching pattern (BBM not shown). Complementary switching of C and D while A is continuously ON and B is continuously OFF means that the regulator is acting as a Boost regulator. In this case a Boost regulator with leading edge modulation.

FIG. 4C shows a case where VEA2 is only slightly higher than VEA1. For this case, VEA1 intersects ramp voltage VY and VEA2 intersects ramp voltage VX. This means that comparators C and D are both producing square wave outputs and, as a result all four switches are actively switching. Switches A and B are operating as they would in a Buck regulator with trailing edge modulation. Switches C and D are operating as they would in a Boost Regulator with leading edge modulation. Thus, the regulator is operating as a Buck-Boost regulator.

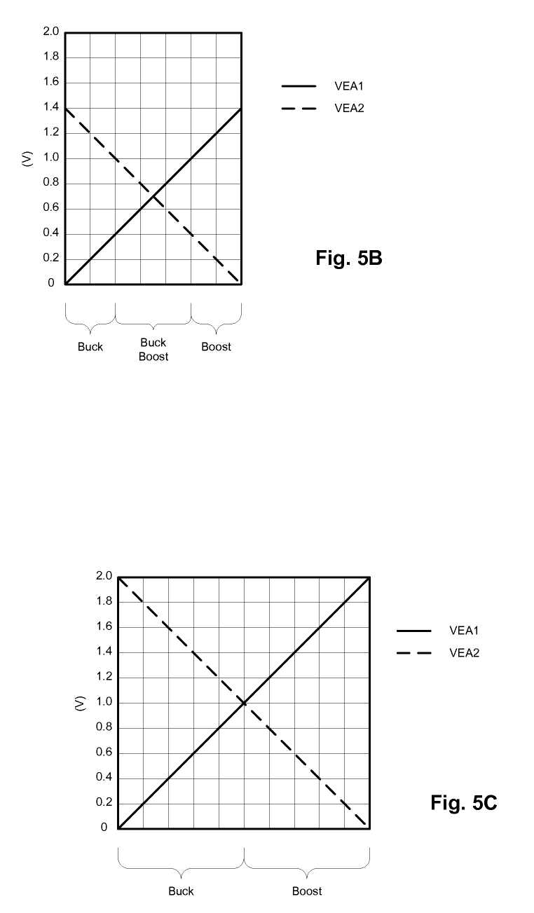

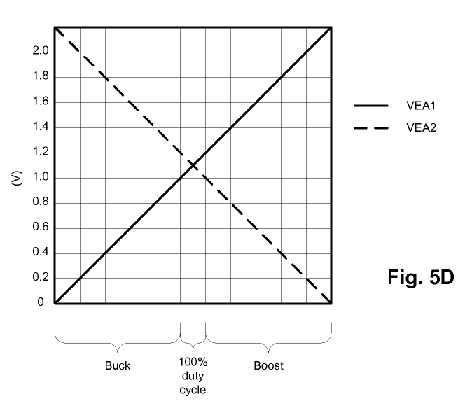

As may be surmised, the regulator of FIG. 2 has a transition zone where it operates as a Buck-Boost regulator and not as a Buck or Boost regulator. The size of this transition zone is defined by the value chosen for the voltage Ve. For example, consider an implementation where the peak of the ramp voltages VX and VY is one volt (i.e., Vp equals one volt). Assume also that the voltage Ve is 0.9·Vp. This means that VEA2=1.8−VEA1. As shown in FIG. 5A, this establishes an area labeled “Buck” where VEA2 is greater than Vp causing the Boost switches (C and D) of the regulator to idle. VEA1, on the other hand is less than Vp meaning that the Buck switches (A and B) are actively switching.

A second region labeled “Buck-Boost” includes the range where both VEA1 and VEA2 are less than Vp and all four switches are actively switching. A third region labeled “Boost” includes the range where VEA1 is greater than Vp and VEA2 is less than Vp. This idles the Buck switches and causes the Boost switches to actively switch.

FIG. 5B shows a second example where Ve is 0.7·Vp and Vp=1.0V. This means that VEA2=1.4−VEA1 and has the result of greatly expanding the Buck-Boost region and diminishing the Buck and Boost regions. This results in a regulator that operates in Buck-Boost mode over a wider range of operating conditions.

Similarly, FIG. 5C shows a third example where Ve is 1.0·Vp. and VEA2=2.0−VEA1. This means that VEA1 becomes greater than Vp (disabling the Buck switches) just as VEA2 becomes less than Vp (enabling the Boost switches). For this reason, there is no region where the all four switches are simultaneously switching and the regulator never operates as a Buck-Boost regulator.

Finally, FIG. 5D shows a fourth example where Ve is 1.1·Vp. and VEA2=2.2−VEA1. As was the case with FIG. 5A, this example has separate Boost and Buck regions. In this case however, these two regions are not separated by a Buck-Boost region. Instead, they are separated by a region in which both VEA1 and VEA2 are greater than Vp. As a result, neither the Buck switches nor the Boost switches are actively switching. As a result, the regulator operates as either a Buck regulator or a Boost regulator at a 100% duty cycle in this region where the input voltage is close to the output voltage.

As shown above, the use of two ramp voltages (VX and VY) separated in phase by 180° combined with the use of two intersecting voltages (VEA1 and VEA2) provides a seamless transition between Boost, Buck-Boost and Buck modes of operation. The use of trailing edge modulation for the Buck switches and leading edge modulation for the Boost switches allows the width of the Buck-Boost region to be minimized without adversely impacting stability. In this way, the present invention provides a Buck-Boost switching regulator that maximizes efficiency (by minimizing four switch operation) and minimizes output ripple.

What is claimed is:

1. A circuit for controlling a buck-boost switching regulator where the switching regulator includes two buck switches and two boost switches, the circuit comprising:
a circuit for generating a periodic ramp voltage VX and a periodic ramp voltage VY where VX and VY having a phase difference of 180 degrees;
an error amplifier for generating a voltage VEA1 that is proportional to the output of the switching regulator;
an amplifier for generating a voltage VEA2 that is inversely proportional to VEA1;
a first comparator for comparing the ramp voltage VY to the voltage VEA1 to generate an output that defines the duty cycle of the buck switches; and
a second comparator for comparing the ramp voltage VX to the voltage VEA2 to generate an output that defines the duty cycle of the boost switches.

2. A circuit as recited in claim 1 where the buck switches include a control switch connected between an input node and an inductor and where the first comparator turns the control buck switch OFF whenever the ramp voltage VY exceeds the voltage VEA1.

3. A circuit as recited in claim 1 where the boost switches include a free-wheeling switch connected between an inductor and ground and where the second comparator turns the free-wheeling buck switch ON whenever the ramp voltage VX exceeds the voltage VEA2.

4. A circuit as recited in claim 1 where the amplifier is configured to generate VEA2 by inverting VEA1 and adding a voltage offset.

5. A circuit as recited in claim 4 where the magnitude of the voltage offset is selected to provide three different operating modes including a boost mode where the boost switches have a non-zero duty cycle, a buck mode where the buck switches have a non-zero duty cycle and a buck-boost mode where the boost and buck switches have non-zero duty cycles.

6. A circuit as recited in claim 1 where the first amplifier generates a pulse width modulated signal with trailing edge modulation to define the duty cycle of the buck switches and where the second amplifier generates a pulse width modulated signal with leading edge modulation to define the duty cycle of the boost switches.

7. A circuit for controlling a buck-boost switching regulator where the switching regulator includes at least one buck switch and at least one boost switch, the circuit comprising:
a circuit for generating a periodic ramp voltage VX and a periodic ramp voltage VY where VX and VY having a phase difference of 180 degrees;
an error amplifier for generating a voltage VEA1 that is proportional to the output of the switching regulator;
an amplifier for generating a voltage VEA2 that is inversely proportional to VEA1;
a first comparator for comparing the ramp voltage VY to the voltage VEA1 to generate an output that defines the duty cycle of the buck switches; and
a second comparator for comparing the ramp voltage VX to the voltage VEA2 to generate an output that defines the duty cycle of the boost switches.

8. A circuit as recited in claim 7 where the first comparator turns the buck switch OFF whenever the ramp voltage VY exceeds the voltage VEA1.

9. A circuit as recited in claim 7 where the second comparator turns the buck switch ON whenever the ramp voltage VX exceeds the voltage VEA2.

10. A circuit as recited in claim 7 where the amplifier is configured to generate VEA2 by inverting VEA1 and adding a voltage offset.

11. A circuit as recited in claim 10 where the magnitude of the voltage offset is selected to provide three different operating modes including a boost mode where the boost switch has a non-zero duty cycle, a buck mode where the buck switch has a non-zero duty cycle and a buck-boost mode where the boost and buck switches have non-zero duty cycles.

12. A circuit as recited in claim 7 where the first amplifier generates a pulse width modulated signal with trailing edge modulation to define the duty cycle of the buck switches and where the second amplifier generates a pulse width modulated signal with leading edge modulation to define the duty cycle of the boost switches.

13. A method for operating a buck-boost switching regulator, where the switching regulator includes two buck switches and two boost switches, the method comprising:
generating a ramp voltage VX and a ramp voltage VY where VX and VY having a phase difference of 180 degrees;
generating a voltage VEA1 that is proportional to the output of the switching regulator;
generating a voltage VEA2 that is inversely proportional to VEA1;
comparing the ramp voltage VY to the to voltage VEA1 to generate an output that defines the duty cycle of the two buck switches; and
comparing the ramp voltage VX to the to voltage VEA2 to generate an output that defines the duty cycle of the two boost switches.

14. A method as recited in claim 13 where the buck switches include a high-side switch connected between an input node and an inductor and where the method further comprises turning the high-side buck switch OFF whenever the ramp voltage VY exceeds the voltage VEA1.

15. A method as recited in claim 13 where the boost switches include a low-side switch connected between an inductor and ground and where the method further comprises turning the low-side buck switch ON whenever the ramp voltage VX exceeds the voltage VEA2.

16. A method as recited in claim 13 that further comprises generating VEA2 by inverting VEA1 and adding a voltage offset.

17. A method as recited in claim 16 where the magnitude of the voltage offset is selected to provide three different operating modes including a boost mode where the boost switches have a non-zero duty cycle, a buck mode where the buck switches have a non-zero duty cycle and a buck-boost mode where the boost and buck switches have non-zero duty cycles.

18. A circuit as recited in claim 13 where the output that defines the duty cycle of the two buck switches is a pulse width modulated signal with trailing edge modulation and where the output that defines the duty cycle of the two boost switches is a pulse width modulated signal with leading edge modulation.

19. A method for operating a buck-boost switching regulator, where the switching regulator includes at least one buck switch and at least one boost switch, the method comprising:
generating a ramp voltage VX and a ramp voltage VY where VX and VY having a phase difference of 180 degrees;
generating a voltage VEA1 that is proportional to the output of the switching regulator;
generating a voltage VEA2 that is inversely proportional to VEA1;
comparing the ramp voltage VY to the to voltage VEA1 to generate an output that defines the duty cycle of the buck switch; and
comparing the ramp voltage VX to the to voltage VEA2 to generate an output that defines the duty cycle of the boost switch.

20. A method as recited in claim 19 that further comprises turning the high-side buck switch OFF whenever the ramp voltage VY exceeds the voltage VEA1.

21. A method as recited in claim 19 that further comprises turning the low-side buck switch ON whenever the ramp voltage VX exceeds the voltage VEA2.

22. A method as recited in claim 19 that further comprises generating VEA2 by inverting VEA1 and adding a voltage offset.

23. A method as recited in claim 22 where the magnitude of the voltage offset is selected to provide three different operating modes including a boost mode where the boost switch has a non-zero duty cycle, a buck mode where the buck switch has a non-zero duty cycle and a buck-boost mode where the boost and buck switches have non-zero duty cycles.

24. A circuit as recited in claim 19 where the output that defines the duty cycle of the two buck switches is a pulse width modulated signal with trailing edge modulation and where the output that defines the duty cycle of the two boost switches is a pulse width modulated signal with leading edge modulation.
